(19) United States
(12) Patent Application Publication
(10) Pub. No.: US 2004/0131082 A1
(43) Pub. Date: Jul. 8, 2004

(54) Construction of middleware adapters

(76) Inventors: James C. Evans, Maple Grove, MN (US); Balaji Ramaswamy, Bloomington, MN (US); Parvathi Saraswathyammal, Longmont, CO (US); Danesh Zaki, Tamilnadu (IN)

Correspondence Address: Beck & Tysver, P.L.L.C., Suite 100, 2900 Thomas Avenue S., Minneapolis, MN, 55416, US

(21) Appl. No.: 10/359,969

(22) Filed: Feb. 6, 2003

Related U.S. Application Data
(60) Provisional application No. 60/355,256, filed on Feb. 8, 2002.
(60) Provisional application No. 60/356,494, filed on Feb. 12, 2002.
(60) Provisional application No. 60/367,139, filed on Mar. 22, 2002.

(51) Int. Cl. H04J 3/16

(52) U.S. Cl. 370/469

(57) ABSTRACT

A thick middleware adapter is presented that handles data related services within the adapter itself using generally reusable components connected in series. On the sending side of a communication, these components first convert the data from the native format of the application into raw XML. Next, the raw XML is transformed into the canonical XML defined by the enterprise using an XSLT stylesheet. The data is then validated and compressed, and then combined with a middleware message header. Another component in the adapter is the responsible for chunking, grouping, and encryption of the message, while a last component submits the completed message to the middleware transport layer. The components in a receiving adapter perform the opposite functions to convert the message received from the middleware transport layer into a message that is understood by the receiving application.

### CLAIM OF PRIORITY

This application claims priority to the following three provisional patent applications: U.S. Serial No. 60/355,256 filed Feb. 8, 2002; U.S. Serial No. 60/356,494 filed Feb. 12, 2002; and U.S. Serial No. 60/367,139 filed Mar. 22, 2002, all of which are hereby incorporated by reference.

### FIELD OF THE INVENTION

This invention relates to the field of message-oriented middleware.

More particularly, the present invention relates to the construction and assembly of adapters that are used to connect one application to another over a message-oriented middleware.

### BACKGROUND OF THE INVENTION

In order to meet the computing needs of a typical enterprise, it is necessary to operate numerous distinct computing platforms simultaneously. Spread over these various platforms, separate business software applications together handle the data processing needs of the enterprise. For example, in a retail company, separate business applications may handle merchandising, supply chain, and order management. Although these business applications and computer platforms are not generally designed to communicate with one another, it has long been recognized that some inter-program communication is required for an efficiently operating computing environment.

One class of software that allows such communication is known as message-oriented middleware. This type of middleware allows messages to be sent between a sending and a receiving business application program through the use of message queues. From a logical standpoint, the middleware uses a middleware transport layer to deliver messages over an underlying communications network layer. When a first business application wishes to communicate with a second business application, the first application composes a message and places this message in a message queue from which it is routed to a queue of the destination application. The message remains on the destination queue until the destination program receives the message from the queue, thereby providing asynchronous communication between the two applications. The middleware transport layer provided by the message-oriented middleware handles all aspects of queue maintenance and message delivery. As a result, it is not necessary to build this capability into each of the business application programs that communicate with each other.

It is necessary, however, to make sure that each business application is able to send and receive messages through the middleware transport layer. This is accomplished through the use of adapters that operate between the application programs and the middleware transport layer. The adapters convert communications emanating from the application into the messages understood by the middleware transport layer, and vice versa. In doing so, the adapters either communicate with the application program directly through the program's application program interface (or API), or are capable of extracting data from a file or database created and maintained by the application program.

In addition, each application will likely have its own particular format for data that it would like to share across an enterprise. Thus, it is usually necessary to transform the data being transmitted over a middleware transport layer from the format of the sending application into a format understood by the receiving application. In some prior art middleware settings, this transformation occurs within the adapters, with each adapter being capable of converting between the data format of its application into a standard, canonical data structure defined for the enterprise as a whole. If the adapters do not have this ability, it is necessary for a message broker provided by the middleware application to handle the data transformations.

In addition to data format transformation, it is sometimes necessary to perform additional actions on the data before it is transmitted between applications. For instance, data being transmitted over a middleware transport layer is often compressed for transmission efficiency. In addition, if the message is being sent over a public network or via other insecure means, it is prudent to encrypt the message prior to transmission. In fact, certain information may require encryption even when it is sent over an internal network. It may also be necessary to group short messages together into a single transmission, or to chunk large messages into several shorter transmissions. Regardless of whether a message is compressed, encrypted, grouped, or chunked after being sent by the sending application, it will be necessary to perform the opposite service before the message can be understood by the receiving application.

The steps of data transformation, compression, chunking, grouping, and encryption can be performed in only three locations, namely in the applications themselves, in the adapters, or in a middleware broker. Locating these services in the applications would require significant application reprogramming. This would, of course, defeat the primary benefit of middleware systems, since middleware exists to allow inter-program communications without significant reprogramming. Instead, most prior art systems have placed the data transformation and encryption services in the middleware product itself. The approach of placing most or all of these services in the middleware product creates “thin” adapters, meaning that the adapters have limited capabilities and complexities. All of the complexity is located in the “thick” middleware brokers. The use of thin adapters allows the adapter to be streamlined to focus on granting an application access to the message format of the middleware, which in turn eases the creation of the numerous adapters that must be created in the traditional enterprise computing environment. The use of thin adapters also allows the vendor's software to be more efficient and to minimize the footprint of the adapter on the sender and receiver ends.

An unfortunate consequence of the use of thin middleware adapters is that an enterprise becomes reliant on the services performed by a particularly vendor's middleware application. Enterprises wishing to take advantage of these services must design their adapters to request the specific service from a particular middleware application. Since each vendor provides different levels of services, the enterprise becomes dependent on particular services being available using a particular interface. In addition, the use of thin adapters requires the use of a message broker to handle data transformations, which requires establishing a complex table of data transformations between all applications wishing to communicate over the middleware transport layer. What is needed to avoid the dependencies on middleware vendors is a reliable way of producing thick middleware adapters that incorporates these data services directly in the adapter without creating undue complexity that greatly increases the time to develop each adapter.

### SUMMARY OF THE INVENTION

The present invention overcomes the limitations in the prior art by providing a unique construction for a thick middleware adapter that provides most or all of the data related services within the adapter itself. This allows the use of a “thin” middleware application that is primarily responsible only for message delivery and maintenance. As a consequence, the enterprise does not become reliant on a particular middleware software provider, and will be able to change to any middleware application capable of communicating by JMS or another agnostic middleware interface. In addition, the use of thick middleware adapters allows the use of a common, canonical data structure to exist on the middleware transport layer. Each adapter is responsible only for converting data between the data format of its application and the canonical data structure, which simplifies data transformation across the enterprise. The present invention accomplishes this without undue complexity by subdividing the services into components that can easily be reused in different adapters.

The particular adapter construction of the present invention connects these reusable components in series. On the sending side of a communication, these components take a message pushed or pulled from an application and modify the message into a form appropriate for the middleware transport layer. On the receiving side, similar components receive the message from the middleware transport layer, and convert the message into a format that will be recognized by the receiving application.

More specifically, the present invention adapter uses a communicator, a payload assembler, a message assembler, a middleware message sender, and a transport-specific (e.g., JMS or FTP) sender. The communicator component is responsible for interfacing directly with the business application program. Hence, all of the peculiarities of a particular business application are isolated to this communicator component, which allows the rest of the adapter to be defined and programmed independently of the business application and to be largely reusable from adapter to adapter. The communicator is also responsible for converting data from the native format of the application to “raw” XML. Raw XML generally reflects the organization and content of the data as it is represented in the business application; it is a temporary representation before the data is converted into the generic, or canonical form, used for a particular data type (e.g., Customer or Invoice) for adapter-to-adapter communication.

The payload assembler receives raw XML from the communicator and transforms the data into the canonical XML for that particular data topic. This transformation is governed by a process that uses an XSLT (Extensible Stylesheet Language for Transformations) stylesheet, which is well known in the prior art. Once the data is transformed into a canonical XML “document”, it may be validated according to the data topic's XML Schema, another well-known prior art. The decision on whether or not to validate the done depends on how the adapter is configured. The message assembler compresses the validated, canonical XML data payload received from the payload assembler. The message assembler then adds the message header necessary for transmission over the middleware transport layer. The middleware message sender is responsible for chunking, grouping, and encryption. Finally, the JMS (or another transport-specific) sender submits the completed message to the middleware transport layer. On the receiving side, similar components perform the opposite tasks to convert the message received from the middleware transport layer into a communication understood by the receiving business application.

### BRIEF DESCRIPTION OF THE DRAWINGS

FIG. 1 is a schematic drawing showing a sending application transmitting a message to a receiving business application over a middleware transport layer using sending and receiving adapters.

FIG. 2 is a schematic drawing showing an initiator application and a respondent application communicating over a middleware transport layer using a request and reply paradigm.

FIG. 3 is a schematic drawing showing the details of the sending and receiving adapters of FIG. 1.

FIG. 4 is a schematic drawing showing the details of the initiator and respondent communicators shown in FIG. 3.

FIG. 5 is a schematic drawing showing the details of the payload assembler and disassembler shown in FIG. 3.

FIG. 6 is a schematic drawing showing the details of the message assembler and disassembler shown in FIG. 3.

FIG. 7 is a schematic drawing showing the details of the middleware message sender and receiver shown in FIG. 3.

### DETAILED DESCRIPTION OF THE INVENTION

Adapter Functionality

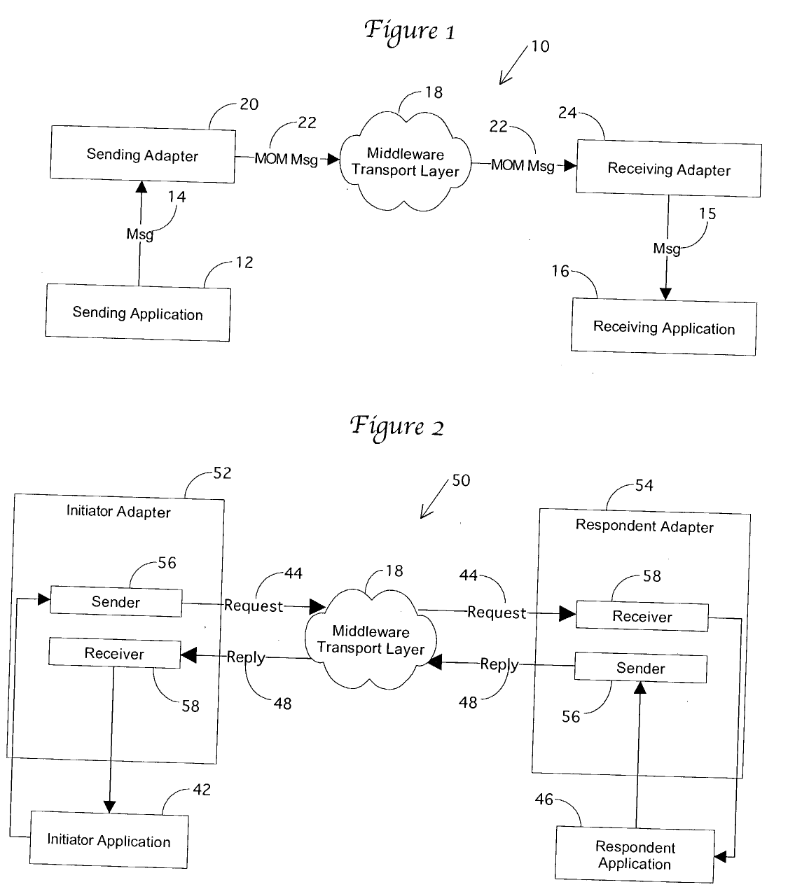

FIG. 1 is a schematic representation of a simple point-to-point communication 10 in which a sending application 12 sends a message 14 to a receiving application 16 over a middleware transport layer 18. The middleware transport layer 18 can be provided by any of the widely available message-oriented middleware products, such as WebSphere® MQ (formerly known as MQSeries®) from IBM (Armonk, N.Y.). The middleware transport layer 18 is designed to transport messages that comport with its message format (i.e., with a header containing destination information), which is likely unknown to the sending application 12. Hence, the sending application 12 uses a sending adapter 20 to receive the message 14 and convert it into a format 22 acceptable to the middleware transport layer 18 for delivery to the receiving application 16. The receiving application 16 uses a receiving adapter 24 to accept the MOM formatted message 22 from the middleware transport layer 18, and convert it into a message format 15 that is understood by the receiving application.

It is possible for a particular adapter to be responsible for both sending and receiving a message over the middleware transport layer 18. This is shown in FIG. 2, in which an initiator application 42 sends a request 44 for particular data to a respondent application 46. The respondent application 46 receives the request 44, and responds with a reply message 48 containing the data desired by the initiator application 42. In practice, the middleware transport layer 18 is oblivious to the fact that it is being used to conduct a request/reply interaction 50. From its point of view, the communication 50 is essentially the combination of two separate two point-to-point messages; one originating at the initiator application 42 and the second originating at the respondent application 46. The intelligence for handling this transaction as a request and reply paradigm communication is found within the adapters 52, 54 and applications 42, 46. The initiator adapter 52 contains a both sender component 56, which sends the request 44 to the middleware transport layer 18, and a receiver component 58 for receiving the reply 48. Similarly, the respondent adapter 54 contains a receiver 58 for receiving the request 44, and a sender 56 for sending the reply 48.

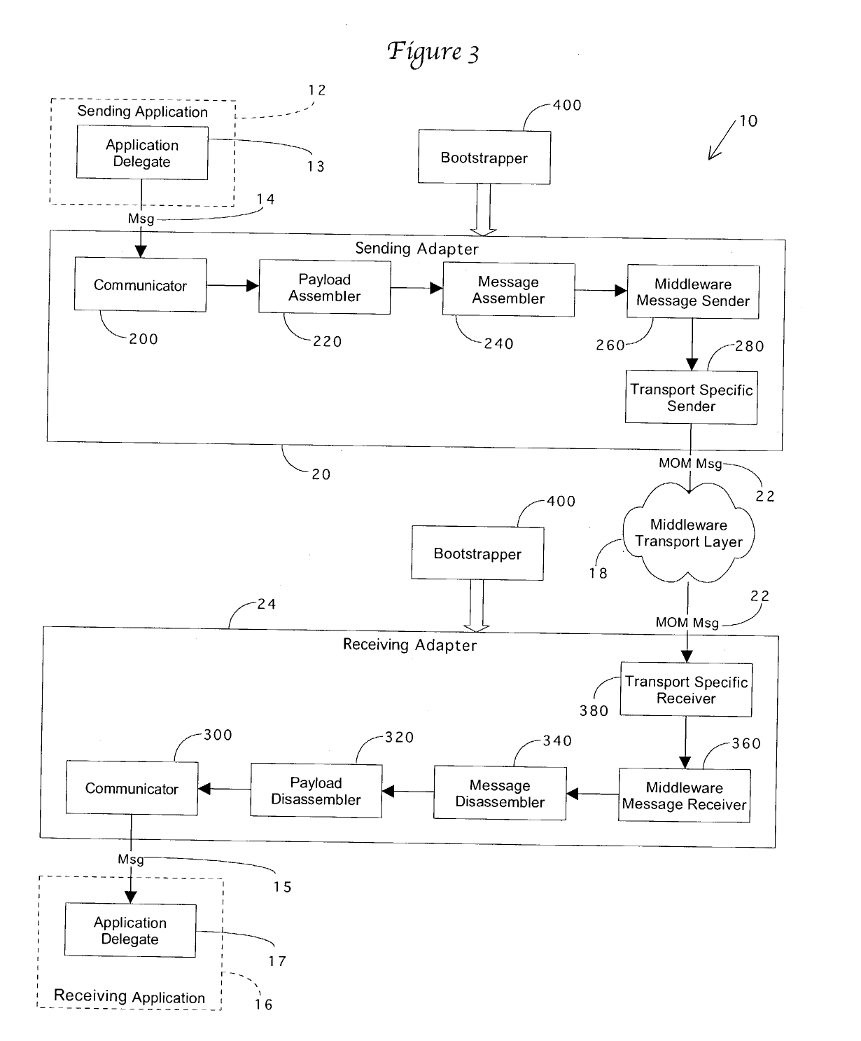

The present invention of a componentized, thick adapter can be used in either the straightforward point-to-point communication 10 of FIG. 1 or in more complicated paradigms such as the request/reply communication 50 of FIG. 2. In FIG. 3, the present invention is shown in more detail in the context of the point-to-point communication 10 of FIG. 1.

Components of an Adapter

As seen in FIG. 3, sending adapter 20 receives a message 14 from the sending application 12, and converts it to a MOM message 22 understood by the middleware transport layer 18. This is accomplished using numerous components 200-280 that process and massage the message 14 into the MOM format message 22. These components receive the message from the sending application 12, convert the data into the appropriate XML format and schema, compress the message, add a message header, handle any desired encryption, chunking, or grouping, and submit the message to the middleware transport layer 18 using JMS. The adapter 20 is also responsible for performing an ACL check, monitoring the status of the messages, performing data validation, verifying access privileges, and logging its activity.

The first component shown in FIG. 3 is the communicator 200. This component is responsible for all communication with the sending application 12. More specifically, the communicator is responsible for communication with an application delegate 13, which is an interface designated by the sending application 12. The application delegate 13 could be the standard API (application program interface) for the application 12. Alternatively, the application delegate 13 could be a data file maintained and accessed by the application 12 for the sole purpose of communicating with the adapter 20 and the middleware transport layer 18. The information communicated between the application delegate 14 and the communicator 200, which is shown on FIG. 3 as message 14, even though this information 14 is not formatted as a middleware message at this point.

The data or message 14 sent through the application delegate 13 will pertain to a specific topic, and could contain either data or a request that information be provided or action be taken. That is, the information elements in the message 14 will relate to a single, logical data structure or object defined for an enterprise, such as a customer, a shipment, or a product, or a request for information about such business objects. Any data received in message 14 will be formatted using the data format of the sending application 12. The communicator 200 is responsible for understanding this data format and converting the data into a raw XML data format.

The payload assembler 220 takes this raw XML data and converts it using a transformation specification, such as Extensible Stylesheets for Transformation (XSLT), into a standard, canonical XML that the enterprise has previously defined for the data topic. The payload assembler 220 then optionally validates this canonical XML against a predefined transformation schema, such as an XML Schema, and presents this validated, canonical XML data to the message assembler 240.

The message assembler 240 is responsible for compressing the data message received from the payload assembler 220 and then adding the message header that is expected by the middleware transport layer 18. The middleware message sender 260 then is able to provide the encryption, chunking, or grouping services that are desired for this message 14. Once these services are applied to the message, it is submitted to the transport specific sender 280, which formats the message for the message transport layer 18 as MOM message 22. In the preferred embodiment, the transport specific sender 280 is a JMS sender that formats the message into the JMS standard. Alternatively, the transport specific sender 280 could translate the message into an FTP message, or to any other open or proprietary message protocol used by the message transport layer 18.

The middleware transport layer 18 delivers the MOM message 22 to the receiving adapter 24, which then processes the MOM message 22 into a format 15 understood by the receiving application 16. This is accomplished using the same basic components 200-280 used in the sending adapter 20, except that the components 300-380 in the receiving adapter 24 perform the opposite functions. Hence, the transport specific receiver 380 receives the formatted message 22 in the transport specific format (such as JMS) and delivers it to the middleware message receiver 360. The middleware message receiver 360 must decrypt, ungroup, and de-chunk the message as necessary based upon the services performed on the message 22 when it passed through the middleware message sender 260. Because the middleware message receiver 360 must know what happened in the sending adapter 20, it is generally necessary to create the sending and receiving adapter 20, 24 in pairs. Thus, the middleware message sender 260 and the middleware message receiver 360 will both know which services will be performed on the MOM messages 22, and will be able to share such things as the encryption/decryption keys that are used.

Once the middleware message receiver 360 un-groups and decrypts the received MOM message, the message disassembler 340 removes the header from the message and decompresses the data payload. The payload is then provided to the payload disassembler 320, which is responsible for taking the canonical XML created by the payload assembler 220 and converting it back into raw XML data. The communicator 300 of the receiving adapter 24 then converts the raw XML data into the native format of the receiving application 16. Once the data is so converted, it is presented to the application delegate 17 of the receiving application 16 as message 15. This application delegate 17 is much like the application delegate of the 13 of the sending application 12, in that the delegate 17 can range from a data file accessed by the receiving application 16 to the standard API of the receiving application 16.

FIG. 3 also shows two components labeled bootstrapper 400. The bootstrapper 400 is responsible for starting the adapter 20 at the appropriate time. The bootstrapper 400 may form part of the application program 12, may be a specialized program whose sole purpose is to launch adapter 20, or may even be a centralized program that monitors and manages numerous adapters 20, 24 throughout an entire enterprise.

Communicator

FIG. 4 reveals the functional components of the initiator communicator 200 and the respondent communicator 300. Both communicators 200, 300 are responsible for allowing the adapters 20, 24 to communicate with their respective application delegates 13, 17. Hence, each communicator 200, 300 must be custom tailored for the application delegates 13, 17. More specifically, the initiator communicator 200 must have a subcomponent 202 that is custom developed for extracting the data message 14 from the application delegate 13. Similarly, the respondent communicator 304 has a subcomponent 302 for submitting the data message 15 to the receiving application's application delegate 17. Object-oriented subclassing is used to consolidate for reuse at various levels what communicators have in common (i.e., all communicators; all communicators interacting with SQL databases; all communicators interacting with text files). Inventories of subclasses covering a variety of the more commonly encountered situations minimize development costs.

In addition to the extract and submit data subcomponents 202, 302, the communicators 200, 300 must be able to convert between the data formats used by the applications 12, 16 into XML formatted data. In the initiator communicator 200, this is accomplished through subcomponent 204 that converts data from the format of the application 12 into raw XML. In the respondent communicator 300, the similar subcomponent 304 converts raw XML (now specific for the respondent) into the data format 15 of the receiving application 17.

Finally, the preferred embodiment initiator communicator 200 has a permissions checking subcomponent 206. This subcomponent verifies that its sending application 12 has permission to send a message over the middleware transport layer 18 on the particular data topic. This is accomplished through the use of an LDAP access control list, as is well known in the prior art. The particular access control list of the preferred embodiment operates by receiving a topic, application name, and location (assuming the same application runs at multiple locations in an enterprise) from the permissions-checking subcomponent 206. The LDAP access control list will, preferably, be centrally located and will provide middleware access control for multiple adapters throughout an enterprise. The access control list verifies that the sending application 12 has permission to communicate on the requested topic over the middleware transport layer 18. If so, the access control list returns an authorization to the permissions-checking subcomponent 206 that allows the message 14 to be sent over the middleware transport layer 18. Since this security is implemented at the initiator adapter 20, there is no need for similar security procedures to be defined and maintained by the middleware transport layer 18. Subscribing adapters request that access to a particular topic be authorized at the time of subscription.

Payload Assembler and Disassembler

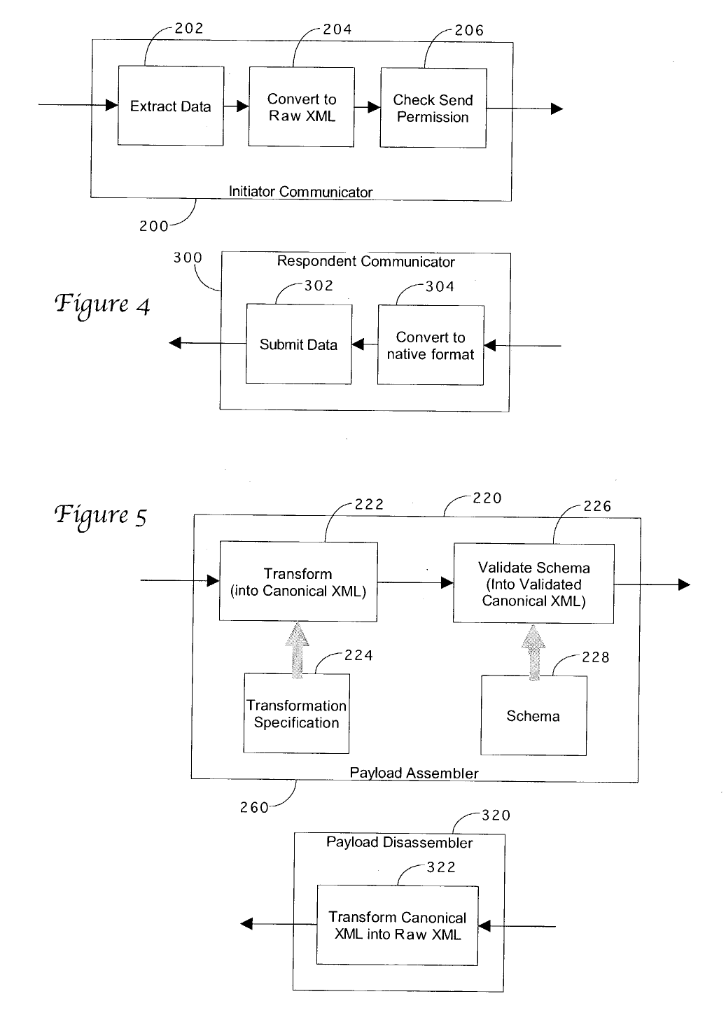

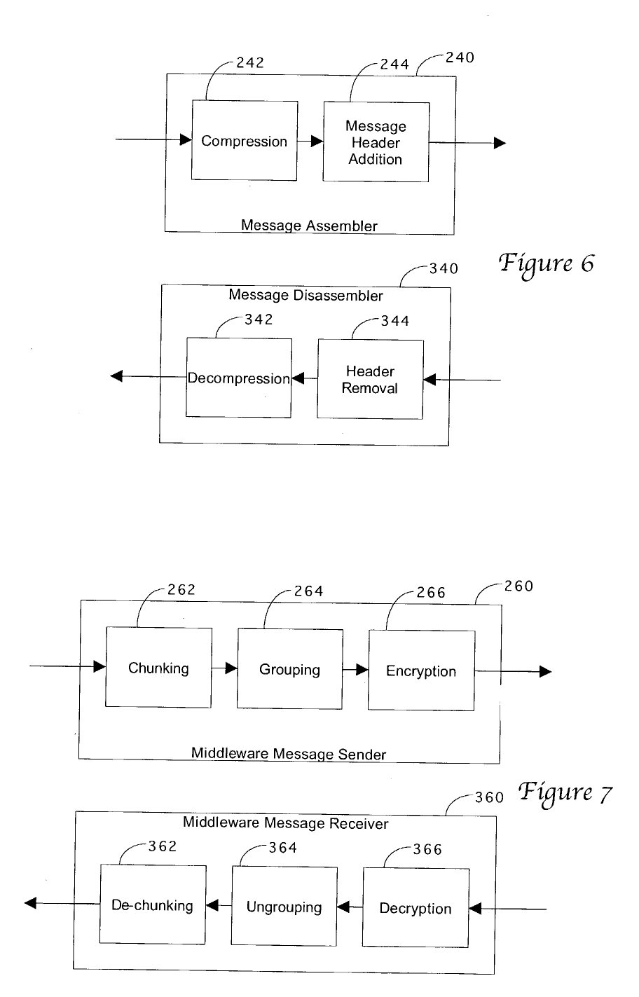

The payload assembler 220 and disassembler 320 are seen in more detail in FIG. 5. The payload assembler 220 receives raw XML from the initiator communicator 200. Subcomponent 222 then transforms this raw XML into canonical XML using a transformation specification 224, such as an XSLT stylesheet, that the enterprise has previously defined for this data topic.

It is usually desirable to validate the canonical XML data against a schema definition 228 for the data topic, which is performed by the schema-validating subcomponent 226. Because schema validation can be a computationally intensive operation, the schema-validating subcomponent 226 is optional, and may be invoked only on a subset of message 14 communications.

The transformation specification or stylesheet 224 and schema 228 can be stored in the payload assembler 220 or can be received from a centralized location. One way of providing centralized storage of the stylesheet 224 and schema 228 is to store them in association with the LDAP access control list used by the permissions-checking subcomponent 206. When the control list returns permission to subcomponent 206, the stylesheet 224 and schema 228 could be sent along with the permission confirmation. The central storage of the stylesheet 224 and schema 228 would allow these data specifications to be altered at one location, and have the alterations take place throughout an enterprise without recreating each adapter.

On the receiving adapter 24, the payload disassembler 320 is responsible only for transforming the canonical XML back into raw XML format. This is accomplished by the sole subcomponent 322 shown in FIG. 5 for payload disassembler 320.

Message Assembler and Disassembler

The message assembler 240 and disassembler 340 each have two components that perform nearly identical, but opposite functions. The compression subcomponent 242 compresses the data payload received from the payload assembler 220 using standard compression techniques. Similarly, the decompression subcomponent 342 uses the same techniques to decompress the data payload before submitting it to the payload disassembler. Of course, not every adapter 20, 24 of the present invention will contain the compression 242 and decompression 342 components, because the compression of MOM messages 22 across the message transport layer 18 is not always necessary or desired. The decision on whether to compress the MOM message 22 can be made at the time the adapter pair 20, 24 is created, which will determine whether the compression components 242, 342 are included in the adapters 20, 24.

The message header addition subcomponent 244 takes the compressed payload and adds the message header necessary for sending a MOM message 22 over the middleware transport layer 18. The message header is removed in the message disassembler 340 by the header removal subcomponent 344, which then submits the remaining payload to the decompression subcomponent 342 for decompression.

Middleware Message Sender and Receiver

The middleware message sender 260 and receiver 360 are responsible for any chunking, grouping, and encryption that are desired for MOM messages 22 sent over the middleware transport layer 18. Chunking and de-chunking are accomplished by subcomponents 262, 362 respectively. Similarly, grouping and ungrouping are accomplished by subcomponents 264, 364, respectively, while encryption and decryption are handled by subcomponents 266, 366, respectively. As explained above, in order for the middleware message receiver 360 to properly handle a received MOM message 22, it must have knowledge of the services performed by the subcomponents 262-266 of the middleware message sender 260. This is generally accomplished by creating the sending adapter 20 and receiving adapter 24 in pairs, so that only the necessary components 262-266, 362-366 are incorporated within each adapter 20, 24. In this way, the optional services of chunking, grouping, and encryption can be selected at the time of creation, and only those components 262-266, 362-366 that are desired will be included in the middleware message sender 260 and receiver 360.

The invention is not to be taken as limited to all of the details thereof as modifications and variations thereof may be made without departing from the spirit or scope of the invention. For instance, even though the above description refers to XML schemas and XSLT stylesheets, it would be a simple matter to implement the present invention using other data handling protocols, such as by using Java code instead of XSLT stylesheets. Furthermore, the above description explains how middleware adapters can perform schema validation, encryption, access control, data transformation, grouping, and chunking services. One skilled in the art would be aware that these services are not needed in every data communication, and therefore it would not be necessary for all of these services to exist within an adapter constructed according to the present invention. Consequently, the invention should be limited only by the following claims.

What is claimed is:

1. A middleware adapter responsible for communicating a message-oriented middleware message concerning a data topic between an application program and a middleware transport layer comprising:
a) a communicator programmed to interact with the application program, the communicator converting data from a data format used by the application program into raw XML data;
b) a payload assembler programmed to transform data from the raw XML data into canonical XML data predefined for the data topic;
c) a message assembler programmed to add a message header to the canonical XML data for use by the middleware transport layer; and
d) a sender component programmed to submit the canonical XML data with the message header to the middleware transport layer as the message-oriented middleware message.

2. The middleware adapter of claim 2, further comprising:
e) a middleware message sender programmed to perform data services on the canonical XML data before being submitted by the sender component, the data services being selected from a group consisting of chunking, grouping, and encrypting services.

3. The middleware adapter of claim 1, wherein the sender component submits the message-oriented middleware message to the middleware transport layer using a vendor-agnostic middleware interface.

4. The middleware adapter of claim 3, wherein the vendor-agnostic middleware interface is JMS.

5. The middleware adapter of claim 1, wherein the message assembler is further programmed to compress the canonical XML data before adding the message header.

6. The middleware adapter of claim 1, wherein the payload assembler is further programmed to validate the canonical XML data against a predefined transformation schema.

7. The middleware adapter of claim 6, wherein the payload assembler transforms the raw XML data into the canonical XML data using an XML Stylesheet and further wherein the predefined transformation schema is an XML Schema.

8. The middleware adapter of claim 7, wherein the XML Stylesheet and the XML Schema are provided to the payload assembler from outside of the middleware adapter only after a permissions checking component of the adapter verifies that the application program has permission to send the message over the middleware transport layer concerning the data topic.

9. The middleware adapter of claim 1, further comprising a permissions checking component programmed to verify that the application program has permission to send the message over the middleware transport layer concerning the data topic.

10. The middleware adapter of claim 9, wherein the permissions checking component determines the permission by accessing an LDAP access control list.

11. A system for communicating a message concerning a data topic between a sending application and a receiving application over a message oriented middleware comprising:
a) a sending application delegate used by the sending application to send the message in a sending application format;
b) a receiving application delegate used by the receiving application to receive the message in a receiving application format;
c) a middleware transport layer programmed to send the message formatted in a message-oriented middleware format from the sending application to the receiving application;
d) a sending adapter programmed to accept the message from the sending application delegate in the sending application format and to submit the message to the middleware transport layer in the message-oriented middleware format, the sending adapter having:
i) a sending communicator programmed to interact with the sending application delegate, the sending communicator converting data in the message accepted from the sending application delegate between the sending application format and a raw XML data format,
ii) a payload assembler programmed to transform data from the raw XML data format into a canonical XML data format predefined for the data topic,
iii) a message assembler programmed to add a message header to the canonical XML formatted data for use by the middleware transport layer, and
iv) a sender component programmed to submit the canonical XML formatted data with the message header as the message-oriented middleware formatted message to the middleware transport layer; and
e) a receiver adapter programmed to receive the message from the middleware transport layer and to submit the message to the receiving application delegate in the receiving application format, the receiver adapter having:
i) a receiver component programmed to receive the message-oriented middleware formatted message from the middleware transport layer,
ii) a message disassembler programmed to remove the message header from the message received by the receiver component,
iii) a payload disassembler programmed to transform data between the canonical XML formatted data and raw XML data, and
iv) a receiving communicator programmed to interact with the receiver application delegate, the receiving communicator converting data between raw XML data and the receiving application format.

12. The system of claim 11, wherein the sender component submits the message to the middleware transport layer using a vendor-agnostic middleware interface.

13. The system of claim 12, wherein the vendor-agnostic middleware interface is JMS.

14. The system of claim 11, wherein the message assembler is further programmed to compress the canonical XML formatted data before adding the message header and the message disassembler is further programmed to decompress the canonical XML formatted data after removing the message header.

15. The system of claim 11, wherein the sender adapter further comprises:
v) a middleware message sender programmed to perform sending data services on the canonical XML formatted data before being submitted by the sender component, the sending data services being selected from a group consisting of chunking, grouping, and encrypting services.

16. The system of claim 15, wherein the receiver adapter further comprises:
v) a middleware message receiver programmed to perform receiving data services on the message-oriented middleware formatted message received by the receiver component, the receiving data services being selected from a group consisting of de-chunking, ungrouping, and decrypting services, whereby the receiving data services of the middleware message receiver reverses the sending data services of the middleware message sender.

17. The system of claim 11, wherein the payload assembler is further programmed to validate the canonical XML data format against a predefined transformation schema.

18. The system of claim 17, wherein the predefined transformation schema is an XML Schema.

19. The system of claim 17, wherein the payload assembler transforms the raw XML data into a canonical XML data using an XML Stylesheet and further wherein the predefined transformation schema is an XML Schema.

20. The system of claim 19, wherein the sending adapter further comprises a sender permissions checking component, and further wherein the XML Stylesheet and the XML Schema are provided to the payload assembler from outside of the sending adapter only after the sender permissions checking component verifies that the sending application program has permission to send the message over the middleware transport layer concerning the data topic by accessing an LDAP access control list.

21. The system of claim 11, wherein the sending adapter further comprises a sender permissions checking component programmed to verify that the sending application has permission to send a message over the middleware transport layer concerning the data topic.

22. The system of claim 21, wherein the sender permissions checking component determines the permission by accessing an LDAP access control list.

23. The system of claim 21, wherein the receiving adapter further comprises a receiver permissions checking component programmed to verify that the receiving application has permission to subscribe to the data topic.

24. The system of claim 23, wherein the permissions checking components verify permissions by accessing an LDAP access control list.

25. A middleware adapter responsible for communicating a message concerning a data topic between an application program and a middleware transport layer comprising:
a) a communicator programmed to interact with the application program, the communicator converting data from a data format used by the application program into raw XML data;
b) a payload assembler programmed to transform data from the raw XML data into a canonical XML data format predefined for the data topic and to validate the canonical XML data format against a predefined transformation schema.;
c) a message assembler programmed to compress the canonical XML data and to add a message header to the canonical XML data for use by the middleware transport layer;
d) a middleware message sender programmed to perform data services on the canonical XML data and message header, the data services being selected from a group consisting of chunking, grouping, and encrypting services; and
e) a sender component programmed to submit the canonical XML data with message header to the middleware transport layer as a message-oriented middleware message.

26. The middleware adapter of claim 25, wherein an XML Stylesheet and an XML Schema are provided to the payload assembler from outside of the middleware adapter only after a permissions checking component verifies that the application program has permission to send the message over the middleware transport layer concerning the data topic.
